(19) United States
(12) Patent Application Publication
(10) Pub. No.: US 2011/0138009 A1
(43) Pub. Date: Jun. 9, 2011

(54) Methods, Systems and Computer Program Products for Tracking Creations on the Internet

(76) Inventor: Nancy Grover, San Diego, CA (US)

(21) Appl. No.: 12/633,905

(22) Filed: Dec. 9, 2009

(51) Int. Cl. G06F 15/16; G06F 3/00; G06F 15/173

(52) U.S. Cl. 709/217; 715/745; 709/223; 707/E17.116

(57) ABSTRACT

Methods of tracking information on the Internet are provided. The method includes associating a virtual tracking device with content to be uploaded to the Internet; uploading the content with the virtual tracking device to the Internet; and receiving a report including at least one virtual location associated with the uploaded content, the at least one virtual location being identified using the virtual tracking device associated with the content. Related systems and computer program products are also provided.

### BACKGROUND OF THE INVENTION

The present application relates generally to communications, and, more particularly, to methods, systems, and computer program products for tracking creations on the Internet.

With the popularity of websites like Facebook and YouTube, blogging and social networking sites many people post original videos, art, digital photos, articles, stories and the like to share these creations with others online. Once these original creations are available on the Internet, they can be copied by others and these people can claim ownership of them, even though they do not really own them. The only protection available for such creations is to place some sort of branding, or watermark on the original work and hope someone doesn't come along and remove it.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Some embodiments provide methods of tracking information on the Internet. The method includes associating a virtual tracking device with content to be uploaded to the Internet; uploading the content with the virtual tracking device to the Internet; and receiving a report including at least one virtual location associated with the uploaded content, the at least one virtual location being identified using the virtual tracking device associated with the content.

In further embodiments, receiving the report may be preceded by reporting the at least one virtual location to a database; storing the at least one virtual location at the database; and creating the report based on the stored at least one virtual location.

In still further embodiments, associating the virtual tracking device with the content may be preceded by downloading a virtual tracking device application associated with the virtual tracking device.

In some embodiments, the virtual tracking device may be a Web bug and the content may be original creations of a user.

In further embodiments, the at least one virtual location may include an internet protocol (IP) address of a device accessing the content, a universal resource locator (URL) of a page on the Internet where the content resides, a time stamp, a previous site cookie and/or a type of browser used.

In still further embodiments, receiving may be followed by determining if at least one of the at least one virtual location associated with the uploaded content is acceptable to an owner of the uploaded content; and removing the uploaded content from the at least one of the at least one virtual location if it is determined that the at least one of the at least one virtual location is not acceptable to the owner of the content.

Although embodiments are discussed primarily above with respect to method embodiments, system and computer program product embodiments are also provided herein.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a system including a communications device and database in accordance with some embodiments.

FIG. 2 is a block diagram of a data processing system suitable for use in some embodiments.

FIG. 3 is a more detailed block diagram of a system according to some embodiments.

FIGS. 4 and 5 are flowcharts illustrating operations according to various embodiments.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification are taken to specify the presence of stated features, steps, operations, elements, and/or components, but do not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another.

Exemplary embodiments are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Python, Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

As discussed above, as the popularity of the Internet continues to increase, many people create videos and art, take digital photos, and write articles or stories that they want to share with others online. For example, these original creations may be posted on a personal website, a blog, Flickr, a social networking site or the like. Once these original creations are posted online, they can be copied and others may claim ownership of these creations. Thus some embodiments discussed herein provide personal digital rights management (DRM) using “Reverse Web Bugs.” This allows users to track their creations and claim ownership thereof when these creations are posted online.

In particular, according to some embodiments, a user may add personal DRM protection to any media posted on the Internet using a “Reverse Web Bug.” Web Bugs are currently used by web site owners to track and log visitors to their sites. For example, a Web bugs may be a 1.0 pixel×1.0 pixel represented by HTML IMG files. The Web bug is configured to send information back to the web site owner. The information sent by the Web bug can include, for example, an internet protocol (IP) address of the computer accessing the page, a uniform resource locator (URL) of the page where the Web Bug resides, a time stamp, previous site cookies and the type of browser used.

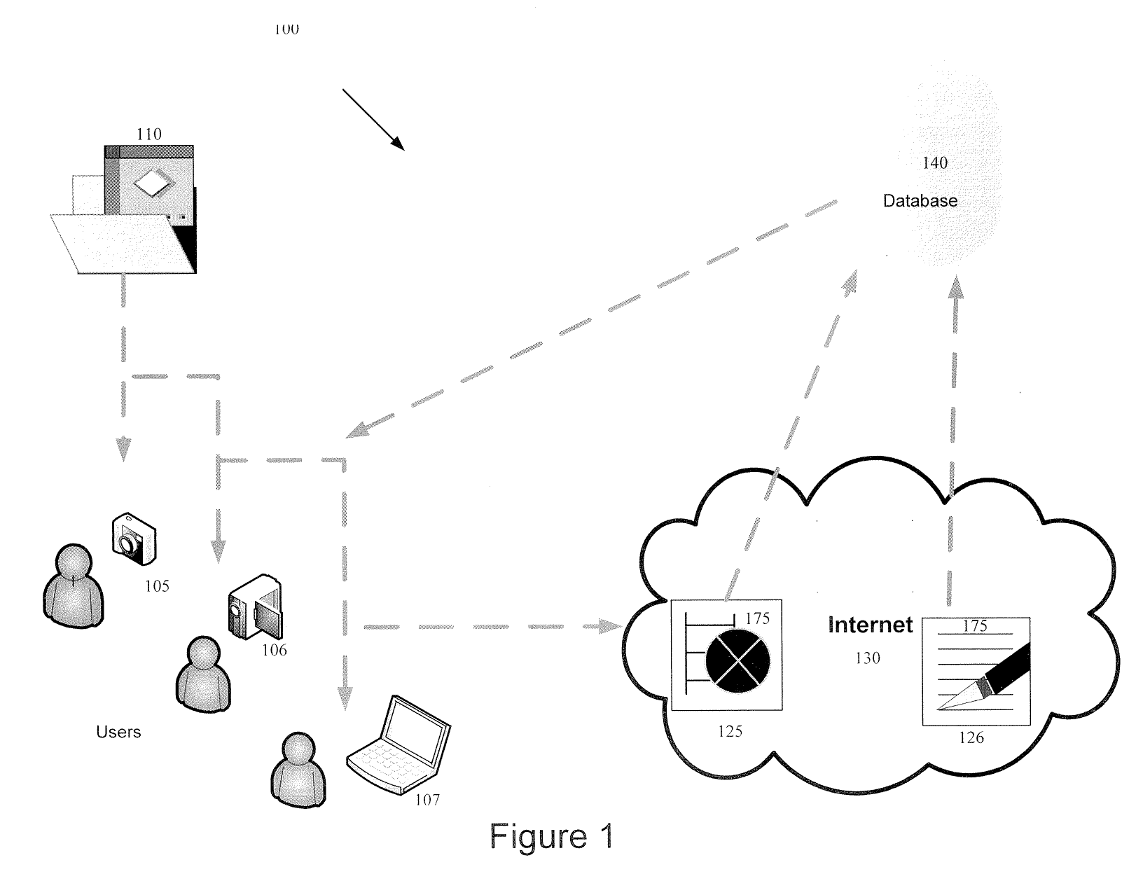

A “Reverse Web Bug” in accordance with some embodiments allows a “bug” to be embedded in the media, such as picture, music, video, etc. The reverse web bugs are configured to periodically send a report including virtual locations associated with where the uploaded media is on the Internet. The report can include the IP/URL of the site the media is residing on, time stamps, etc. In some embodiments, this information can be stored at a centralized database. Periodically, the user receives the report indicating where their media appears on the Internet. If the user does not approve of the postings, they can use the information gathered by the “bug” or “virtual tracking device” to contact the site owner and ask that the media be removed. Details of the “virtual tracking device” in accordance with some embodiments will be discussed further below with respect to FIGS. 1 through 5.

It will be understood that some content owners may not care if their content is shared, and may only want to use the embodiments discussed herein to track how far the information posted has spread or to ensure they are receiving proper credit for the posted information. Content owners such as bloggers, video makers, etc. may fall into this category.

Referring now to FIG. 1, a system 100 including a “virtual tracking device” 175 and a database 140 in accordance with some embodiments will be discussed. As illustrated in FIG. 1, the system 100 includes, a virtual tracking device application 110, a plurality of devices 105, 106 and 107, a network 130 and a database 140.

Exemplary operations according to some embodiments, will be discussed with respect to FIG. 1. A user of a device, for example, a digital camera 105, a digital video camera 106 or a personal computer 107, downloads a virtual tracking device application 110 to the device 105, 106 and 107. The virtual tracking device application 110 according to some embodiments is configured to embed a virtual tracking device 175 in an original creation 125, 126 at the device 105, 106 and 107 before the original creation 125, 126 is uploaded to the Internet 130. The content (original creation) 125, 126 is posted on the Internet 130. The virtual tracking device 175 embedded in the content 125, 126 is configured to report a virtual location of the content to the database 140. The database 140 is configured to create a report including the virtual locations of the content reported by the virtual tracking devices 175 associated with the uploaded content 125, 126. The database 140 is further configured to periodically provide the report to the user so that the user can track their content on the Internet. As discussed above, the user can choose to request that the content be removed from one or more particular locations or the user may just use the tracking device to have the knowledge of where the content is and how far it has traveled.

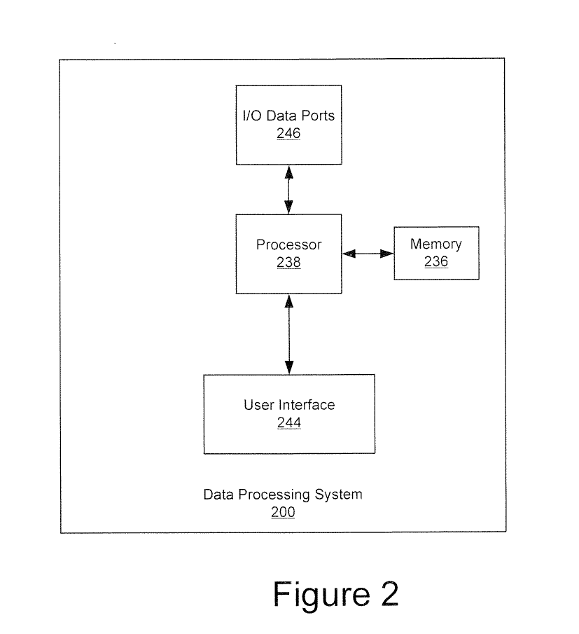

Referring now to FIG. 2, a data processing system 200 in accordance with some embodiments will be discussed. The data processing system 200 may be used to embed virtual tracking devices in content and track the content thereby in accordance with some embodiments. As illustrated in FIG. 2, the data processing system 200 may include a user interface 244, including, for example, input device(s) such as a keyboard or keypad, a display, a speaker and/or microphone, and a memory 236 that communicate with a processor 238. The data processing system 200 may further include I/O data port(s) 246 that also communicates with the processor 238. The I/O data ports 246 can be used to transfer information between the data processing system 200 and another computer system or a network, such as the Internet, using, for example, an Internet Protocol (IP) connection. These components may be conventional components such as those used in many conventional data processing systems, which may be configured to operate as described herein.

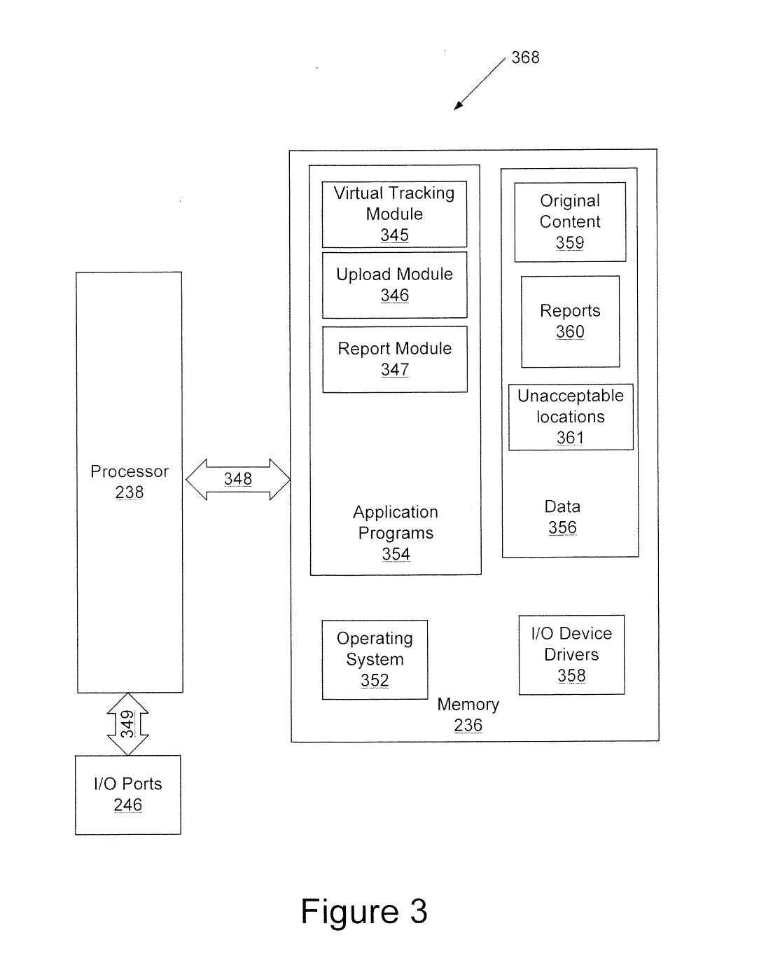

Referring now to FIG. 3, a more detailed block diagram of a data processing system 368 for implementing systems, methods, and computer program products in accordance with some embodiments will now be discussed. It will be understood that the application programs and data discussed with respect to FIG. 3 below may be present in, for example, a communications device or database in accordance with some embodiments without departing from the scope of embodiments discussed herein.

As illustrated in FIG. 3, the processor 238 communicates with the memory 236 via an address/data bus 348 and with I/O port 246 via address/data bus 349. The processor 238 can be any commercially available or custom enterprise, application, personal, pervasive and/or embedded microprocessor, microcontroller, digital signal processor or the like. The memory 236 may include any memory device containing the software and data used to implement the functionality of the data processing system 200. The memory 236 can include, but is not limited to, the following types of devices: ROM, PROM, EPROM, EEPROM, flash memory, SRAM, and DRAM.

As further illustrated in FIG. 3, the memory 236 may include several categories of software and data used in the system 368: an operating system 352; application programs 354; input/output (I/O) device drivers 358; and data 356. As will be appreciated by those of skill in the art, the operating system 352 may be any operating system suitable for use with a data processing system, such as OS/2, AIX or zOS from International Business Machines Corporation, Armonk, N.Y., Windows95, Windows98, Windows2000 or WindowsXP, Windows Vista, Windows7 or Windows CE from Microsoft Corporation, Redmond, Wash., Palm OS, Symbian OS, Cisco IOS, VxWorks, Unix or Linux. The I/O device drivers 358 typically include software routines accessed through the operating system 352 by the application programs 354 to communicate with devices such as the I/O data port(s) 246 and certain memory 236 components. The application programs 354 are illustrative of the programs that implement the various features of the system 368 and may include at least one application that supports operations according to embodiments. Finally, as illustrated, the data 356 may include original content 359, reports 360 and unacceptable locations 361, which may represent the static and dynamic data used by the application programs 354, the operating system 352, the I/O device drivers 358, and other software programs that may reside in the memory 236.

As further illustrated in FIG. 3, according to some embodiments, the application programs 354 include a virtual tracking module 345, an upload module 346 and a report module 347. While the present invention is illustrated with reference to the virtual tracking module 345, the upload module 346 and the report module 347 being application programs in FIG. 3, as will be appreciated by those of skill in the art, other configurations fall within the scope of embodiments discussed herein. For example, rather than being application programs 354, these circuits or modules may also be incorporated into the operating system 352 or other such logical division of the system 368. Furthermore, while the virtual tracking module 345, the upload module 346 and the report module 347 are illustrated in a single system 368, as will be appreciated by those of skill in the art, such functionality may be distributed across one or more systems. Thus, the embodiments discussed herein should not be construed as limited to the configuration illustrated in FIG. 3, but may be provided by other arrangements and/or divisions of functions between data processing systems. For example, although FIG. 3 is illustrated as having various circuits/modules, one or more of these circuits/modules may be combined without departing from the scope of embodiments discussed herein.

The virtual tracking module 345 is configured to associate a virtual tracking device 175 (FIG. 1) with content 359 to be uploaded to the Internet. In some embodiments, the virtual tracking device may be a Web bug and the content may be original creations of a user, for example, pictures, videos, poetry and the like. The upload module 346 is configured to upload content that has been associated with the virtual tracking device to the Internet. The report module 347 is configured to receive a report 360 including virtual locations associated with the uploaded content. The virtual locations are identified using the virtual tracking device 175 (FIG. 1) associated with the content. The virtual locations may include, for example, an internet protocol (IP) address of a device accessing the content, a universal resource locator (URL) of a page on the Internet where the content resides, a time stamp, a previous site cookie and/or a type of browser used.

In some embodiments, a virtual tracking device application is downloaded to the device that uploads the content to the internet. The virtual tracking device application is configured to attach the virtual tracking device to the content such that the content can be tracked according to some embodiments.

As illustrated in FIG. 1, the system further includes a database 140 (FIG. 1). The database is configured to receive the virtual locations of the uploaded content from a virtual tracking device associated with the uploaded content. The received virtual locations of the uploaded content is stored at the database. The report is created based on the stored virtual locations and then sent to the report module 347 of the device that uploaded the content.

Once the report is received, the virtual tracking module 345 is configured to determine the virtual locations associated with the uploaded content is acceptable to an owner of the uploaded content. The uploaded content may be removed any of the virtual locations deemed unacceptable 361 to the owner of the content.

As discussed above, some content owners may not want to remove the content from locations identified by the virtual tracking device, but just track the movement of the content.

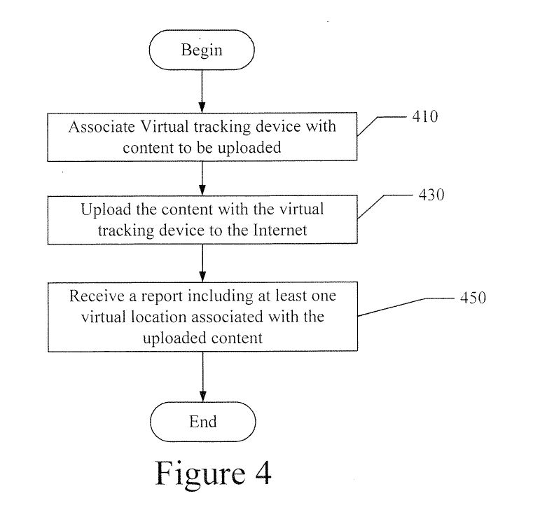

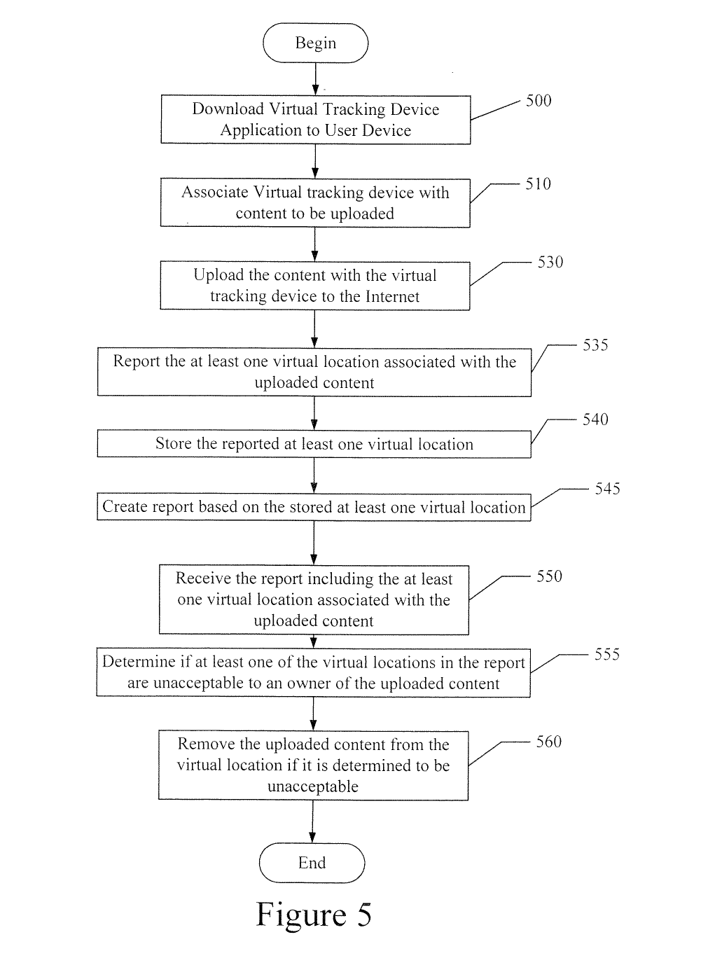

Operations in accordance with various embodiments will now be discussed with respect to FIGS. 4 and 5. Referring first to FIG. 4, operations for tracking information on the Internet begin at block 410 by associating a virtual tracking device with content to be uploaded to the Internet. The content and the associated virtual tracking device is uploaded to the Internet (block 430). A report is received including virtual locations associated with the uploaded content (block 450). The virtual locations are identified using the virtual tracking device associated with the content. In some embodiments, the virtual tracking device may be a Web bug and the content may be original creations of a user. The virtual locations may include an internet protocol (IP) address of a device accessing the content, a universal resource locator (URL) of a page on the Internet where the content resides, a time stamp, a previous site cookie and/or a type of browser used.

Referring now to FIG. 5, operations begin at block 500 by downloading a virtual tracking device application to the user device that is configured to upload the content. A virtual tracking device is associated with content to be uploaded to the Internet (block 510). The content and the associated virtual tracking device is uploaded to the Internet (block 530). The virtual locations are reported to a database (block 535). The virtual locations are stored at the database (block 540). The report is created based on the stored virtual locations (block 545). The report is received including one or more virtual location associated with the uploaded content (block 450). The one or more virtual locations are identified using the virtual tracking device associated with the content.

Once the virtual locations are identified, it may be determined if the virtual locations associated with the uploaded content is acceptable to an owner of the uploaded content (block 555). If any of the virtual locations are determined to be unacceptable, the uploaded content may be removed from the virtual locations deemed to be unacceptable.

The flowcharts of FIGS. 4 and 5 illustrate the architecture, functionality, and operations of embodiments of methods, systems, and/or computer program products for tracking information on the Internet. In this regard, each block represents a module, segment, or portion of code, which comprises one or more executable instructions for implementing the specified logical function(s). It should also be noted that in other implementations, the function(s) noted in the blocks may occur out of the order noted in FIGS. 4 and 5. For example, two blocks shown in succession may, in fact, be executed substantially concurrently or the blocks may sometimes be executed in the reverse order, depending on the functionality involved.

Many variations and modifications can be made to the embodiments without substantially departing from the principles of the present invention. All such variations and modifications are intended to be included herein within the scope of the present invention, as set forth in the following claims.

That which is claimed:

1. A method of tracking information on the Internet, comprising:
associating a virtual tracking device with content to be uploaded to the Internet;
uploading the content with the virtual tracking device to the Internet; and
receiving a report including at least one virtual location associated with the uploaded content, the at least one virtual location being identified using the virtual tracking device associated with the content.

2. The method of claim 1, wherein receiving the report is preceded by:
reporting the at least one virtual location to a database;
storing the at least one virtual location at the database; and
creating the report based on the stored at least one virtual location.

3. The method of claim 1, wherein associating the virtual tracking device with the content is preceded by downloading a virtual tracking device application associated with the virtual tracking device.

4. The method of claim 1, wherein the virtual tracking device comprises a Web bug and wherein the content comprises original creations of a user.

5. The method of claim 1, wherein the at least one virtual location comprises an internet protocol (IP) address of a device accessing the content, a universal resource locator (URL) of a page on the Internet where the content resides, a time stamp, a previous site cookie and/or a type of browser used.

6. The method of claim 1, wherein receiving is followed by:
determining if at least one of the at least one virtual location associated with the uploaded content is acceptable to an owner of the uploaded content; and
removing the uploaded content from the at least one of the at least one virtual location if it is determined that the at least one of the at least one virtual location is not acceptable to the owner of the content.

7. A system for tracking information on the Internet, comprising:
a communications device including a processor configured to associate a virtual tracking device with content to be uploaded to the Internet, the communications device configured to upload content with the virtual tracking device to the Internet; and receive a report including at least one virtual location associated with the uploaded content, the at least one virtual location being identified using the virtual tracking device associated with the content.

8. The system of claim 7, further comprising a database configured to communicate with the communications device and the Internet, the database being configured to:
receive the at least one virtual location of the uploaded content from a virtual tracking device associated with the uploaded content;
store the received at least one virtual location of the uploaded content at the database; and
create the report based on the stored at least one virtual location.

9. The system of claim 7, wherein the communications device is further configured to download a virtual tracking device application associated with the virtual tracking device.

10. The system of claim 7, wherein the virtual tracking device comprises a Web bug and wherein the content comprises original creations of a user.

11. The system of claim 7, wherein the at least one virtual location comprises an internet protocol (IP) address of a device accessing the content, a universal resource locator (URL) of a page on the Internet where the content resides, a time stamp, a previous site cookie and/or a type of browser used.

12. The system of claim 7, wherein the processor is further configured to:
determine if at least one of the at least one virtual location associated with the uploaded content is acceptable to an owner of the uploaded content; and
remove the uploaded content from the at least one of the at least one virtual location if it is determined that the at least one of the at least one virtual location is not acceptable to the owner of the content.

13. A computer program product for tracking information on the Internet, the computer program product comprising:
a computer readable storage medium having computer readable program code embodied therein, the computer readable program code comprising:
computer readable program code configured associate a virtual tracking device with content to be uploaded to the Internet;
computer readable program code configured to upload the content with the virtual tracking device to the Internet; and
computer readable program code configured to receive a report including a at least one virtual location associated with the uploaded content, the at least one virtual location being identified using the virtual tracking device associated with the content.

14. The computer program product of claim 13, further comprising:
computer readable program code configured to report the at least one virtual location to a database;
computer readable program code configured to store the at least one virtual location at the database; and
computer readable program code configured to create the report based on the stored at least one virtual location.

15. The computer program product of claim 13, further comprising computer readable program code configured to download a virtual tracking device application associated with the virtual tracking device.

16. The computer program product of claim 13, wherein the virtual tracking device comprises a Web bug and wherein the content comprises original creations of a user.

17. The computer program product of claim 13, wherein the at least virtual location comprises an internet protocol (IP) address of a device accessing the content, a universal resource locator (URL) of a page on the Internet where the content resides, a time stamp, a previous site cookie and/or a type of browser used.

18. The computer program product of claim 13, further comprising:
computer readable program code configured to determine if at least one of the at least one virtual locations associated with the uploaded content is acceptable to an owner of the uploaded content; and
computer readable program code configured to remove the uploaded content from the at least one of the at least one virtual location if it is determined that the at least one of the at least one virtual location is not acceptable to the owner of the content.
